(19) United States
(12) Patent Application Publication
(10) Pub. No.: US 2009/0304323 A1
(43) Pub. Date: Dec. 10, 2009

(54) Optical coupling structure and substrate with built-in optical transmission function, and method of manufacturing the same

(76) Inventor: Takahiro Matsubara, Kyoto (JP)

Correspondence Address: NIXON & VANDERHYE, PC, 901 NORTH GLEBE ROAD, 11TH FLOOR, ARLINGTON, VA, 22203, US

(21) Appl. No.: 11/919,060

(22) PCT Filed: Apr. 24, 2006
(86) PCT No.: PCT/JP2006/308576

§ 371 Date: Nov. 26, 2008

(30) Foreign Application Priority Data
Apr. 25, 2005 (JP) 2005-126861
Mar. 30, 2006 (JP) 2006-093062

(51) Int. Cl. G02B 6/12; G02B 6/00; G02B 6/42; B29D 11/00

(52) U.S. Cl. 385/14; 385/141; 385/42; 264/1.24

(57) ABSTRACT

To provide an optical coupling structure that can transmit signal light efficiently and change the light paths, and thereby increase the coupling efficiency of the optical coupling between an optical semiconductor device and optical waveguides.

An optical coupling structure is disclosed that includes optical waveguides optically coupled with an optical path converting surface that is arranged in substrates and an optical semiconductor device mounted on the upper substrate with its active region facing the optical path converting surface, which are optically coupled, via cylindrical refraction index distributors formed of a photosensitive polymer material, arranged so as to go through the portion between the active region of the optical semiconductor device and the optical path converting surface. It is possible to increase the coupling efficiency of the optical coupling between the optical semiconductor device and the optical waveguides, and to realize a high quality and high speed signal transmission at a high energy efficiency.

This application is a U.S. national phase of International Application No. PCT/JP2006/308576 filed 24 Apr. 2006, which designated the U.S. and claims priority to JP 2005-126861 filed 25 Apr. 2005 and JP 2006-093062 filed 30 Mar. 2006, the entire contents of each of which are hereby incorporated herein by reference.

### BACKGROUND OF THE INVENTION

1. Field of the Invention

The present invention relates to an optical coupling structure including optical waveguides and optical transmitters arranged vertically thereto, a substrate with a built-in optical transmission function equipped with this optical coupling structure and a method of manufacturing the same.

2. Description of the Related Art

In order to increase the throughput in information processing and improve the processing speed, there is a trend to increase the operation speed of semiconductor devices and the number of signal input/output terminals for the future. At the same time, the number of signal wires of circuit substrates to which the semiconductor devices are mounted is remarkably increasing, with the wiring density increasing. Along with these trends, the attenuation of signals in electric wires formed on a package board and cross talks among adjacent wires are increasing conspicuously, which is becoming a serious problem. In particular, in large scale semiconductor integrated circuits represented by micro processors, it is a major task to input and output signals at GHz level stably with low power consumption.

In order to solve the problem, examinations have been conducted on optical transmission technology where electric signals that are input to and output from semiconductor devices are converted into optical signals, and signal light to transmit the optical signals is transmitted via optical wires such as optical waveguides and the like formed on package boards.

The photoelectric converting unit converts electric signals to optical signals. At the send-output side of this unit, a laser diode (LD) or a light emitting diode (LED) or the like, which are mainly composed of compound semiconductors, is employed. At its receive-input side, an optical semiconductor device such as a photo diode (PD) composed of silicon (Si) and compound semiconductors is employed.

There are various types of laser diodes. In recent years, the vertical cavity surface emitting laser (VCSEL), which emits light vertically to the main surface of an element substrate, is widely employed as a high-performance and low-cost send light source because preferable crystal is obtained on the crystal growth surface thereof.

Meanwhile, photo diodes of the surface emitting type having a light receiving unit on the crystal surface thereof are commonly employed.

Further, as optical wires to transmit signal light, optical waveguides are manufactured from optical glass, single crystal or polymer optical material. These optical waveguides have a high refraction index area as a core portion which is covered with a low refraction index material made as a clad portion

Since the input/output directions of signal light and the optical waveguides formed on the package board are roughly in crossover relation, various proposals are being made regarding the optical coupling structure of these optical semiconductor devices and optical waveguides in order to obtain a high coupled light amount.

FIG. 8 is a cross sectional view showing a representative example of the conventional optical coupling structure according to the prior art, and is an example of the photoelectric wiring substrate disclosed in Patent Document 1. According to the example shown in FIG. 8, an optical wire layer 103 and electric wires 105 are formed on a substrate 100. At the sending side, signal light is emitted from a laser diode 101, as shown by a broken line in the figure, and enters vertically an upper clad portion 103b structuring the optical wire layer 103. Next, the signal light goes through a core pattern 103a and enters a lower clad portion 103c. Then, its transmission direction is changed to the wire direction of the optical wire layer 103 by a mirror component 104 arranged in the optical wire layer 103 in the lower clad portion 103c. Lastly, the signal light enters the core portion 103a of the optical wire layer 103.

Meanwhile, at the receiving side, in the same manner, once the signal light transmitted through the core portion 103a of the optical wire layer 103 reaches the lower clad portion 103c once, its direction is changed upward vertically to the optical wire layer 103. Then, the signal light goes through the core portion 103a and the upper clad portion 103b in the same manner, and thereafter enters a photo diode 102.

Furthermore, although not illustrated herein, in Patent Document 2, optical waveguides are formed between a lower substrate and an upper substrate, and surface type optical semiconductor devices, which are a laser diode and a photo diode, are arranged on the upper substrate. Additionally, the active regions of the respective devices face the substrate surface. Between the respective devices and the optical waveguides, through holes are arranged and transparent resin is arranged therein, and thereby the respective devices and the optical waveguides are optically coupled. Meanwhile, since the optical axes of the respective devices and the optical axes of the optical waveguides run at right angles, a mirror component having a 45-degree optical path changing surface is formed at both ends of the optical waveguides.

### Patent Document 1: Japanese Unexamined Patent Publication (Kokai) No. 2003-50329

### Patent Document 2: Japanese Unexamined Patent Publication (Kokai) No. 2004-20767

However, according to the optical coupling structure shown in FIG. 8, there is a problem that it is not possible to increase the efficiency of the optical coupling between the surface type optical semiconductor devices, or the laser diode 101 and the photo diode 102, and the optical waveguide which is the optical wire layer 103. This arises from the fact that the signal light emitted from the laser diode 101 spreads approximately several tens of degrees at full width at half maximum (or divergence angle). As a result, at the moment when the signal light goes through the optical wire layer 103 and reaches the mirror component 104 just below that, the spot size of the signal light becomes over several times the size at its emission point.

Further, after the direction of the optical path is changed by the mirror component 104, while the signal light transmits through the lower clad portion 103c formed to cover the reflection surface thereof, the signal light spreads radially. Therefore, at the moment when the signal light reaches the core portion 103a of the optical wire layer 103, the spot size of the signal light becomes several times to several ten times the size at its emission point, which is a size much larger than the core portion 103a having a cross sectional size of several ten μm square. As a result, the signal light does not enter the core portion 103 efficiently, and naturally, the transmission level of the signal light in the optical wire layer 103 goes down. Accordingly, this has created a problem in the prior art that a high signal vs. noise ratio (S/N ratio) and a high dynamic range of signal modulation cannot be used.

When the transmission level of the signal light is increased in order to avoid such a problem, it is necessary to increase the current to be applied to the laser diode 101, and thereby the need to increase the light output. For this purpose, the power consumption in the laser diode 101 increases accordingly. In such case, low energy efficiency in the signal transmission cannot be avoided, which has been another problem in the prior art.

Further, at the same time, if an increased current is applied to the laser diode 101, the heat generation in the laser diode 101 increases. Accordingly, this may result in the necessity to add a complicated heat dissipating structure or the degradation of reliability. Furthermore, the heat dissipation from the substrate 100 has adverse effects on the operation of a system using this photoelectric wire substrate, which has been still another problem in the prior art.

Meanwhile, in the optical coupling structure in Patent Document 2, transparent resin is arranged in the through holes arranged between the optical semiconductor devices and the optical waveguides. However, this transparent resin has a uniform refraction index, and accordingly does not have sufficient effect to keep the signal light in and make it totally reflect and transmit it. For this reason, the signal light is likely to be lost.

Furthermore, in the optical coupling structure in Patent Document 2, the 45-degree optical path changing surface is formed by cutting the ends of the optical waveguides by use of a dicer type cutter. However, since the processing direction of the blade of the dicer type cutter is fixed, the light emitting device and the light receiving device are always positioned on the same side of the structure with respect to the optical waveguides. For example, in the case where the optical waveguides are arranged in parallel with the substrate surface of the substrate inside, both the light emitting device and the light receiving device are positioned on the same surface of the substrate. That is, it has not been possible to arrange the light emitting device on one surface, and the light receiving device on the other surface. Accordingly, there has been limited flexibility in the design to freely arrange an optical wire layer between the upper surface and the underside surface of a substrate, and between plural layers included in the substrate, as embodied in the prior-art electric wire substrates.

The present invention has been made in consideration of the above problems in the prior art. Accordingly, an object of the present invention is to provide an optical coupling structure that, in optical coupling between a surface type optical semiconductor device and optical waveguides, can transmit input/output signal light efficiently and change the light paths of the signal light, and thereby increase the coupling efficiency of the optical coupling between the surface type optical semiconductor device and the optical waveguides.

Further, another object of the present invention is to provide a substrate with a built-in optical transmission function that uses the optical coupling structure according to the present invention, and attains a high performance and a high efficiency as well as low power consumption.

Furthermore, still another object of the present invention is to provide a substrate with a built-in optical transmission function where the optical coupling structure according to the present invention can be freely arranged on both surfaces of the substrate and in the inside of the substrate, and a method of manufacturing the same.

### SUMMARY OF THE INVENTION

In order to achieve the above objects, according to the present invention, there are provided the following aspects.

An optical coupling structure according to the present invention includes optical waveguides, cylindrical refraction index distributors in which the refraction index decreases from the central portion toward the peripheral portion in the radial direction, and an optical path changing surface that is optically coupled with both the optical waveguides and the refraction index distributors so as to change optical paths between the optical waveguides and the refraction index distributors.

In the optical coupling structure, the refraction index distributors distribute the refraction index in such a manner that the refraction index decreases from the central portion toward the peripheral portion in the radial direction in a stepwise manner.

In the optical coupling structure, the refraction index distributors distribute the refraction index in such a manner that the refraction index gradually decreases from the central portion toward the peripheral portion in the radial direction in a concentric manner.

In the optical coupling structure, the refraction index distributors are formed of a photosensitive polymer material, and the refraction index is distributed by radiation of ultraviolet light.

In the optical coupling structure, the optical waveguides are formed of a photosensitive polymer material, and core portions and clad portions around the core portions are formed by radiation of ultraviolet light.

In the optical coupling structure, the optical path changing surface is equipped with a light reflection surface that is inclined to the optical axes of the refraction index distributors, and the light reflection surface is formed on bent portions on the boundary surfaces between the core portions and the clad portions of the optical waveguides.

In the optical coupling structure, the optical path changing surface is equipped with a light reflection surface that is inclined at an angle of 45 degrees to the optical axes of the refraction index distributors.

In the optical coupling structure, the optical path changing surface and the ends of the optical waveguides face each other at a distance.

In the optical coupling structure, an optical semiconductor device is further included that optically couples with the optical waveguides via the refraction index distributors and the optical path changing surface and has an active region facing the refraction index distributors.

In the optical coupling structure, the optical semiconductor device is a surface emitting type laser diode or a surface light receiving type photo diode.

A substrate with a built-in optical transmission function according to the present invention includes the optical coupling structure and a substrate, and the optical waveguides and the optical path changing surface are formed in the substrate, and the refraction index distributors are formed through the substrate.

A substrate with a built-in optical transmission function according to the present invention further includes the optical coupling structure, a first substrate, and a second substrate that is arranged in parallel with the first substrate, and the optical waveguides and the optical path changing surface are formed between the first and second substrates, and the refraction index distributors are formed through the first or second substrate.

A substrate with a built-in optical transmission function according to the present invention further includes the optical coupling structure and a substrate, and the optical waveguides and the optical path changing surface are formed on one surface of the substrate, and the optical semiconductor device is arranged on the other surface of the substrate, and the refraction index distributors are formed through the substrate.

A substrate with a built-in optical transmission function according to the present invention further includes the optical coupling structure, a first substrate, and a second substrate that is arranged in parallel with the first substrate, and the optical waveguides and the optical path changing surface are formed between the first and second substrates, and the optical semiconductor device is arranged on the surface opposite to the surface on which the optical waveguides and the optical path changing surface are formed in the first or second substrate, and the refraction index distributors are formed through the first or second substrate.

A substrate with a built-in optical transmission function according to the present invention further includes, a first substrate, and a second substrate that is arranged in parallel with the first substrate, optical waveguides that are formed between the first and second substrates, first and second refraction index distributors that are formed through the first and second substrates respectively at distant positions on the optical waveguides, a first optical path changing surface that optically couples with both the optical waveguides and the first refraction index distributors so as to change optical paths direction between the optical wave guides and the first refraction index distributors, and a second optical path changing surface that optically couples with both the optical waveguides and the second refraction index distributors so as to change optical paths direction between the optical waveguides and the second refraction index distributors, wherein

the optical waveguides, the first refraction index distributors, and the first optical path changing surface form the optical coupling structure, and

the optical waveguides, the second refraction index distributors, and the second optical path changing surface form the optical coupling structure.

A method of manufacturing a substrate with a built-in optical transmission function according to the present invention is a method of manufacturing a substrate with a built-in optical transmission function that includes optical waveguides formed in a substrate, cylindrical refraction index distributors, and an optical path changing surface optically coupled with both the optical waveguides and the refraction index distributors so as to change optical paths direction between the optical waveguides and the refraction index distributors, and the optical path changing surface is equipped with a light reflection surface that is inclined to the optical axes of the refraction index distributors, and the light reflection surface is formed by bending the boundary surfaces between core portions and clad portions of the optical waveguides, wherein

the steps of forming the optical path changing surface include the steps of:

after forming the core portions, removing the core portions at the positions intersecting with the optical axes of the refraction index distributors and thereby forming inclined surfaces on the surfaces of the core portions;

covering the inclined surfaces with a light reflection film and thereby forming the light reflection surfaces; and

forming the clad portions on the core portions including portions on the light reflection film.

A method of manufacturing a substrate with a built-in optical transmission function according to the present invention is a method of manufacturing a substrate with a built-in optical transmission function that includes optical waveguides formed in a substrate, cylindrical refraction index distributors, and an optical path changing surface optically coupled with both the optical waveguides and the refraction index distributors so as to change optical paths direction between the optical waveguides and the refraction index distributors, and the optical path changing surface is equipped with a light reflection surface that is inclined to the optical axes of the refraction index distributors, and the light reflection surface is formed by bending the boundary surfaces between the core portions and the clad portions of the optical waveguides, wherein

steps of forming the optical path changing surface includes the steps of:

before forming the clad portions, forming protrusions at the positions intersecting with the optical axes of the refraction index distributors;

forming the clad portions on the protrusions along the outer ward shape of the protrusions and thereby forming inclined surfaces on the surfaces of the clad portions,

covering the inclined surfaces with a light reflection film and thereby forming the light reflection surfaces; and

forming the core portions on the clad portions including portions on the light reflection film.

According to the optical coupling structure of the present invention, the cylindrical refraction index distributors in which the refraction index decreases from the central portion toward the peripheral portion in the radial direction have a light trapping effect to transmit light while keeping it in the central portion. Accordingly, in the optical coupling structure including the optical waveguides, the refraction index distributors, and the optical path changing surface optically coupled with both so as to change optical paths between them, the light is transmitted efficiently through the refraction index distributors by the light trapping effect of the refraction index distributors. Then, the light efficiently enters the optical path changing surface, changes its light path to the direction of the optical axes of the optical waveguides by the optical path changing surface, and enters the optical waveguides. Furthermore, after being transmitted through the optical waveguides, the light changes the direction of its light path via the optical path changing surface to the direction of the optical axes of the refraction index distributors, and enters the refraction index distributors. Then, the light can be efficiently transmitted through the refraction index distributors by the light trapping effect.

Further, in the optical coupling structure of the present invention, in the case when the refraction index of the refraction index distributors decreases from the central portion toward the peripheral portion in a stepwise manner, the signal light is reflected at the boundary between the refraction index, kept in the high refraction index area at the central portion and transmitted. Accordingly, it is possible to realize a highly efficient signal light transmission in comparison with the case where the refraction index distributors have a uniform refraction index.

Furthermore, in the optical coupling structure of the present invention, in the case when the refraction index of the refraction index distributors gradually decreases from the central portion toward the peripheral portion in a concentric manner, the signal light is kept in the central portion of the refraction index distributors while being transmitted in a snaking manner. Accordingly, it is possible to perform a wide band signal light transmission.

Moreover, in the optical coupling structure of the present invention, the refraction index distributors are formed of a photosensitive polymer material. Accordingly, when a low refraction index area is formed at the peripheral portion of the refraction index distributors by radiation of ultraviolet light, for example, only the central portion is blocked from the light. Then, a mask having an opening is placed above the peripheral portion, and ultraviolet light is radiated through the mask. The refraction index distributors can be formed only with this process. Accordingly, it is possible to realize an optical coupling structure by an easier manufacturing process.

Further, in the optical coupling structure of the present invention, the optical waveguides are formed of a photosensitive polymer material. Thereby, when the clad portions as the low refraction index area are formed around the core portions by radiation of ultraviolet light, only by an exposure process using a photo mask, the optical waveguides can be formed. This photo mask has a dark portion, which blocks off light and corresponds to the core pattern of the optical waveguides. Accordingly, it is possible to finish the manufacturing process of the optical waveguides in a short time, and reduce the manufacturing cost thereof.

Furthermore, in the optical coupling structure of the present invention, in the case where the optical path changing surface is formed by bending the boundary surfaces between the core portions and the clad portions of the optical waveguides, it is not necessary to attach a separate mirror component. Further, when the optical waveguides are formed in the substrate (or between two substrates), the core portions are sandwiched by the upper clad portions and the lower clad portions, and there are two boundary surfaces between the core portions and the clad portions. Therefore, in the case where the optical path is changed to the direction vertical to the direction of the optical axes of the optical waveguides, it is possible to form both the optical path changing surface to change the optical path on one boundary surface between the core portions and the clad portions, and the optical path changing surface to change the optical path on the other boundary surface between the core portions and the clad portions.

Moreover, in the optical coupling structure of the present invention, in the case when the optical path changing surface is equipped with a light reflection surface that is inclined at an angle of 45 degrees to the optical axes of the refraction index distributors, the signal light transmitted along the optical axes is reflected by this surface in the direction orthogonal to the optical axes of the refraction index distributors. Therefore, it is possible to change the transmission direction of the signal light which travels through the refraction index distributors arranged with the optical axes thereof in the direction orthogonal to the surface of the substrate, so as the signal light becomes in parallel with the optical axes of the optical waveguides arranged with the axes thereof in parallel with the surface of the substrate.

Further, in the optical coupling structure of the present invention, in the case when the optical path changing surface and the ends of the optical waveguides face each other at a distance, light transmitted from the optical path changing surface can be coupled with the optical waveguides so as to enter the ends thereof at right angles. Accordingly, it is possible to realize a highly efficient optical coupling between the refraction index distributors and the optical waveguides via the optical path changing surface.

Furthermore, in the optical coupling structure of the present invention, in the case when an optical semiconductor device is further included that optically couples with the optical waveguides via the refraction index distributors and the optical path changing surface, and has an active region facing the refraction index distributors, output light from the active region of the optical semiconductor device can be efficiently transmitted through the refraction index distributors by the light trapping effect of the refraction index distributors. Then, the output light efficiently enters the optical path changing surface, changes its light path to the direction of the optical axes of the optical waveguides by the optical path changing surface. Finally, the light can efficiently enter the refraction index distributors. Further, input light transmitted from the optical waveguides to the active region of the optical semiconductor device changes its optical path to the direction of the optical axes of the refraction index distributors by the optical path changing surface optically coupled with the optical waveguides. Then, the input light enters the refraction index distributors, is efficiently transmitted through the refraction index distributors by the light trapping effect of the refraction index distributors. Finally, the input light can efficiently enter the active region of the optical semiconductor device.

Therefore, according to the optical coupling structure of the present invention, the refraction index distributors having a light trapping effect are arranged, thereby it is possible to realize a coupling efficiency of the optical coupling between the optical semiconductor device and the optical waveguides that is higher than the prior-art structure. It is also possible to realize a high quality and high speed signal transmission at a high energy efficiency.

Moreover, in the optical coupling structure of the present invention, in the case when the optical semiconductor device is a surface emitting type laser diode or a surface light receiving type photo diode, the optical semiconductor device is mounted on the substrate so that the active region thereof faces the refraction index distributor. By simply doing so, a highly efficient optical coupling can be easily structured. Accordingly, it is possible to easily realize a highly efficient optical coupling structure without using any special parts.

According to the substrate with a built-in optical transmission function of the present invention, the optical coupling structure is combined with one or two substrates, the optical waveguides are arranged on the substrate and/or between the substrates, the refraction index distributors are formed on at least one of the one or two substrates and/or the optical semiconductor device is arranged on the substrate. Accordingly, it is possible to attain the same effects as described above with regard to the optical coupling structure.

Consequently, according to the substrate with a built-in optical transmission function of the present invention, by employing the optical coupling structure according to the present invention, it is possible to realize a substrate with a built-in optical transmission function having a high performance and a high efficiency as well as low power consumption.

In the method of manufacturing a substrate with a built-in optical transmission function according to the present invention, in the optical waveguides formed between the first substrate and the second substrate, it is possible to form an optical path changing surface that can be optically coupled with both the refraction index distributors formed in the first substrate and the refraction index distributors formed in the second substrate. That is, in the optical waveguides, the core portions are sandwiched by the upper clad portions and the lower clad portions, and there are two boundary surfaces between the core portions and the clad portions. Therefore, in the case where the optical path is changed between the direction of the optical axes of the optical waveguides and the direction vertical thereto, it is possible to form both the optical path changing surface to change the optical path on one boundary surface between the core portions and the clad portions, and the optical path changing surface to change the optical path on the other boundary surface between the core portions and the clad portions.

### BRIEF DESCRIPTION OF THE DRAWINGS

FIG. 1 is a diagram showing a schematic configuration in a preferred embodiment of an optical coupling structure and a substrate with a built-in optical transmission function equipped with the same according to the present invention.

FIG. 1A is a top view of the substrate, and FIG. 1B is a cross sectional view taken along lines A-A′ in FIG. 1A.

FIGS. 2A to 2D are cross sectional views of a substantial part of an upper substrate 5 at each step of a process showing an example of a preferred embodiment of a method of forming a refraction index distributor in the optical coupling structure according to the present invention.

FIGS. 3A and 3B are cross sectional views of the substantial part of the upper substrate 5 at each step of a process showing an example of a preferred embodiment of another method of forming the refraction index distributor 2 in the optical coupling structure according to the present invention. FIG. 3C is a line drawing showing an example of the refraction index distribution in the radial direction in this refraction index distributor, which is an inclined refraction index distributor.

FIGS. 4A to 4G are cross sectional views of a substantial part of the lower substrate 7 at each step of a process showing an example of a preferred embodiment of a method of forming an optical path changing surface 3a and an optical waveguide 4. In each of the cross sectional views or FIG. 4A to FIG. 4G, a cross sectional view of the substantial part corresponding to the cross sectional view taken along lines A-A′ shown in FIG. 1A is shown on the left side, and a cross sectional view of the substantial part in the orthogonal direction is shown in the right side.

FIG. 5 is a cross sectional view schematically showing another preferred embodiment of the optical coupling structure and the substrate with a built-in optical transmission function using the same according to the present invention.

FIGS. 6A to 6I are figures showing an example of the method of forming the substrate with a built-in optical transmission function shown in FIG. 5.

FIGS. 7A and 7B are figures showing an example of the method of forming the substrate with a built-in optical transmission function shown in FIG. 5.

FIG. 8 is a cross sectional view of the substrate with a built-in optical transmission function according to the prior art.

### DESCRIPTION OF THE PREFERRED EMBODIMENTS

The optical coupling structure and the substrate with a built-in optical transmission function and the method of manufacturing the same according to the present invention will now be described in more detail with reference to the accompanying drawings.

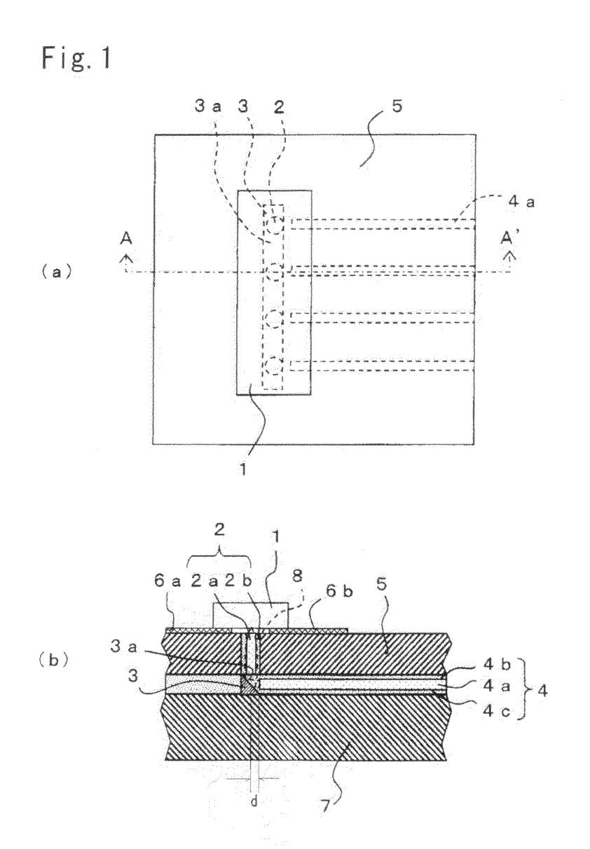

FIG. 1 is a diagram showing a schematic configuration in a preferred embodiment of the optical coupling structure and the substrate with a built-in optical transmission function equipped with the same according to the present invention. FIG. 1A is a top view of the substrate, and FIG. 1B is a cross sectional view taken along lines A-A′ in FIG. 1A.

In FIG. 1, reference numeral 1 denotes an optical semiconductor device, 2 denotes a refraction index distributor, 3 denotes an optical path changing portion having the optical path changing surface denoted by 3a, 4 denotes an optical waveguide, 4a denotes a core portion, 4b denotes an upper clad portion, and 4c denotes a lower clad portion. Further, 5 denotes an upper substrate which is a second substrate to be arranged on a first substrate to be described later herein. 6a and 6b denote an electrode and an electric wire (not shown in (a)) formed on the upper substrate 5 respectively. 7 denotes a lower substrate which is the first substrate. 8 denotes a schematic expression of signal light. By the upper substrate 5 and the lower substrate 7, the substrate with a built-in optical transmission function is structured.

As shown in FIG. 1, the optical coupling structure according to the present invention includes the optical waveguides 4, the refraction index distributors 2, the optical path changing surface 3a that is optically coupled with both the optical waveguides 4 and the refraction index distributors 2 so as to change optical paths between the optical waveguides 4 and the refraction index distributors 2. The refraction index distributors 2 are cylindrical, and the refraction index thereof decreases from the central portion toward the peripheral portion in the radial direction. Additionally, it is preferable that the refraction index distributors 2 are arranged vertically to the optical waveguides 4, however, they may be arranged otherwise, so long as they can be optically coupled with the optical waveguides 4.

In the substrate with a built-in optical transmission function using this optical coupling structure, the optical waveguides 4 optically coupled with the optical path changing surface 3a of the optical path changing portion 3 arranged in the substrate consisting of, for example, the upper substrate 5 and the lower substrate 7 (between the upper substrate 5 and the lower substrate 7), and the optical semiconductor device 1 mounted on the upper substrate 5 with its active region facing the optical path changing surface 3a, are optically coupled via the cylindrical refraction index distributors 2. The refraction index distributors 2 are formed of a photosensitive polymer material and arranged in such a manner that they go through the portion between the active region of the optical semiconductor device 1 and the optical path changing surface 3a.

The optical semiconductor device 1 is a light emitting device such as a laser diode and a light emitting diode and the like, or a light receiving device such as a photo diode or the like. Hereinafter, description will be made with the case where the optical semiconductor device 1 is a light emitting device as an example.

The optical semiconductor device 1 is mounted on electrodes 6a, 6b formed on the upper substrate 5 with its light emitting point (not shown) or the active region facing the upper substrate 5, and its electrodes (not shown) are jointed to the electrodes 6a, 6b. As the joint material, solder alloy and conductive adhesive may be employed. When the optical semiconductor device 1 is mounted, the optical semiconductor device 1 is arranged on a specified position so that the light emitting point is optically coupled with the optical path changing surface 3a via the refraction index distributors 2. In order to realize this, an image processor and the like is used to precisely determine the position for placing the optical semiconductor device 1.

To the optical semiconductor device 1, via the electrodes 6a, 6b, a current is applied in the forward direction from its anode electrode to its cathode electrode. In the case when both the anode electrode and the cathode electrode are arranged on the underside surface of the optical semiconductor device 1, it is possible to apply a current in the forward direction in the mounting/jointing structure as shown in FIG. 1. Additionally, in the case when the anode electrode and the cathode electrode are separately arranged on the underside surface and the upper surface of the optical semiconductor device 1, by a structure (not shown) where a thin metal wire is bonded to the electrode on the upper surface, which is the side opposite the underside surface used as the package surface, it is possible to apply a current in the forward direction. Thereby, light is emitted from the active region of the optical semiconductor device 1 which is a light emitting device.

In the upper substrate 5 structuring the substrate with a built-in optical transmission function, at the position that faces the light emitting point of the optical semiconductor device 1, the cylindrical refraction index distributors 2 formed of a photosensitive polymer material are arranged. Further, the refraction index distributors 2 go through the upper substrate 5 between the light emitting point of the optical semiconductor device 1 and the optical path changing surface 3a of the optical path changing portion 3. The refraction index distributors 2 are cylindrical optical waveguide components of the size corresponding to the active region of the optical semiconductor device 1 and the optical path changing surface 3a as shown in the figure. The diameter of the refraction index distributors 2 is made sufficiently large to the size of the light emitting point of the optical semiconductor device 1 and the light emitted therefrom.

In the refraction index distributors 2, the refraction index thereof is distributed in such a manner so that it is high at the central portion 2a and low at the peripheral portion 2b in the radial direction. Such a concentric refraction index distribution has the light trapping effect to keep the signal light in the central portion. Thereby, the refraction index distributors 2 transmit the signal light along the central axes that are the optical axes. As the refraction index distributors 2, there are largely two kinds. One is a stepwise refraction index distributor where the refraction index of the central portion 2a is, for example, several % higher than that at the peripheral portion 2b, and decreases from the central portion 2a to the peripheral portion 2b in a stepwise manner. The other is an inclined refraction index distributor where the refraction index gradually declines from the central axis to the peripheral portion, and the refraction index gradually decreases from the central portion 2a to the peripheral portion 2b.

It is preferable that the refraction index distributors 2 in the optical coupling structure according to the present invention are formed of a photosensitive polymer material. As the photosensitive polymer material to be used, there are, for example, polysilane system polymer resin that are photobleached, where the refraction index declines with light radiation, or photosensitive acrylic system resin and epoxy resin where the refraction index increases under light radiation. As the light used at this moment, ultraviolet light whose wavelength is in the ultraviolet range is employed. By using such a photosensitive polymer material, it is possible to form the refraction index distributors 2 having the central portion 2a (core portion) and the peripheral portion 2b (clad portion) with a desired refraction index difference, without using an expensive and complicated manufacturing machine such as a machine for core shape processing by vacuum process. That is, it is possible to form the refraction index distributors 2 having a desired refraction index distribution in a short time and at a low cost.

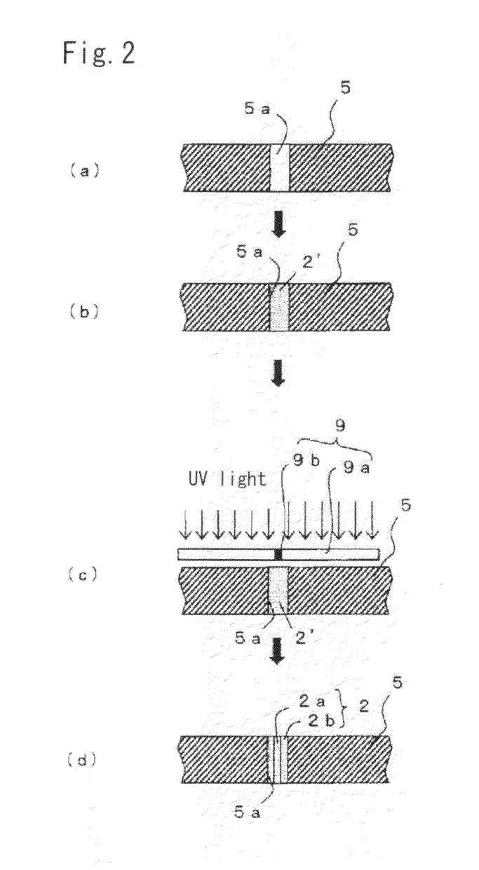

Hereinafter, a method of manufacturing the refraction index distributors 2 in the case where a photosensitive polymer material that is photobleached is used is described with reference to FIG. 2. FIGS. 2A to 2D are cross sectional views of a substantial part of the upper substrate 5 at each step of a process showing an example of a preferred embodiment of a method of forming the refraction index distributors 2 in the optical coupling structure according to the present invention that go through the upper substrate 5.

First, as shown in FIG. 2A, a through hole 5a that goes through the upper substrate 5 is formed. The position of the through hole 5a is determined so that it corresponds to the portion between the position of the active region of the optical semiconductor device 1 to be mounted in a later process, and the position of the optical path changing surface 3a of the optical path changing portion 3 to be formed in a later process.

As the upper substrate 5 and the lower substrate 7 that structure the substrate with a built-in optical transmission function according to the present invention, circuit boards made of organic material, or circuit boards made of ceramics, glass, silicon and the like, used as a circuit board to which the optical semiconductor device 1 is mounted are employed. As the method of forming the through hole 5a in the upper substrate 5, for example, a hole making process by a drill, a hole making process by a laser and the like may be employed.

Next, as shown in FIG. 2B, liquid photosensitive polymer material 2′ is filled into the through hole 5a. As this filling method, an implantation method by a syringe and a suction method by vacuum suction may be employed. When the liquid photosensitive polymer material 2′ is filled into the through hole 5a, filling is performed so that the upper and lower ends thereof should be roughly level with the upper and underside surfaces of the upper substrate 5. The liquid photosensitive polymer material 2′ should not overflow from the through hole 5a or on the contrary it should not be insufficient.

Next, the liquid photosensitive polymer material 2′ is heated at approximately 100° C. for several minutes to perform what is called the pre-baking process. Thereby, the photosensitive polymer material 2′ is cured and solidified.

Next, as shown in FIG. 2C, through a photo mask 9, ultraviolet light is radiated from the direction vertical to the upper substrate 5. As the photo mask 9, for example, a photo mask where a circular light blocking portion 9b with a diameter smaller than the through hole 5a is formed as a mask pattern is used. 9a is a translucent portion. This light blocking portion 9b is formed as the mask pattern to correspond to the central portion 2a of the refraction index distributor 2.

Thereby, as shown in FIG. 2D, the ultraviolet light is radiated only to the peripheral portion of the filled photosensitive polymer material 2′, and the refraction index declines only in the peripheral portion radiated by the ultraviolet light. Thereby, a stepwise refraction index distributor 2 having the central portion 2a as a core portion and the peripheral portion 2b as a clad portion is formed. Herein, the refraction index of the peripheral portion 2b radiated by the ultraviolet light declines in proportion with the radiation time and light amount of the ultraviolet light.

Finally, the whole of the filled photosensitive polymer material 2′ is heated at approximately 100° C. for several ten minutes to perform what is called the post-baking process. Thereby, the curing of the photosensitive polymer material 2′ progresses further, and the refraction index distributor 2 having sufficient hardness and stable characteristics is completed.

Additionally, the refraction index distributor 2 formed by the forming method in FIG. 2 is the stepwise refraction index distributor where the refraction index decreases from the central portion 2a to the peripheral portion 2b in a stepwise manner. Thus, since the refraction index decreases from the central portion 2a to the peripheral portion 2b in a stepwise manner, the respective optical axes of the optical semiconductor device 1 mounted on the upper substrate 5 and the refraction index distributor 2 face in the same direction. Therefore, the signal light is reflected by the boundary surface of the refraction index in the refraction index distributor 2, kept in the high refraction index area of the central portion 2a and transmitted. Additionally, in the case of the stepwise refraction index distribution, it is possible to make the optical coupling efficiency before the signal light enters the refraction index distributor 2 and after it has passed through the same higher than in the case of the inclined refraction index distribution.

In another forming method of the refraction index distributor, a photosensitive polymer material whose refraction index is increased by radiation of ultraviolet light is employed. When such a photosensitive polymer material, for example, acrylic resin or epoxy resin is used, a photo mask having the reverse optical transmittance to that in the manufacturing method by the photo bleaching phenomenon shown in FIG. 2 is employed. On the photo mask, a light blocking portion corresponding to the peripheral portion 2b where the refraction index is decreased is formed, or a translucent portion or an opening corresponding to the central portion 2a, where the refraction index is increased is formed. Then, the same ultraviolet radiation as in FIG. 2 is carried out, thereby a stepwise refraction index distributor 2 having a high refraction index in the central portion 2a thereof can be formed. Alternatively, radiation is carried out by use of a photo mask pattern where the optical transmittance is gradually declined from the opening portion corresponding to the central portion to the peripheral portion, and thereby an inclined refraction index distributor can be formed.

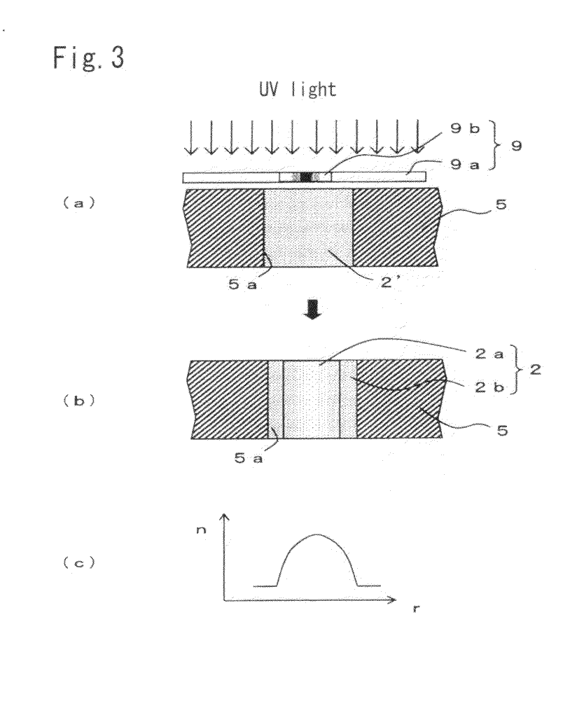

FIG. 3 is a figure showing a method of forming a refraction index distributor 2 having an inclined refraction index distribution given by a photosensitive polymer material that is photobleached. FIGS. 3A and 3B are cross sectional views of the substantial part of the upper substrate 5 at each step of the same process as shown in FIGS. 2C and 2D. In FIGS. 3A and 3B, identical reference numerals are allotted to the same portions as those shown in FIG. 2. As shown in FIG. 3A, when a photo mask 9 with a mask pattern having a light blocking portion 9b where the light transmittance gradually increases from the circular central portion to the peripheral portion of the refraction index distributor 2 is employed, ultraviolet light of the light amount proportional to the light transmittance is radiated to the photosensitive polymer material 2′, thereby the refraction index declines in the radial direction towards the periphery of the peripheral portion. As a result, an inclined refraction index distributor 2 having the central portion 2a as a core portion and the peripheral portion 2b as a clad portion as shown in FIG. 3B can be obtained.

Additionally, an example of the refraction index distribution in the radial direction in this inclined refraction index distributor 2 is shown in the line drawing in FIG. 3C. In FIG. 3C, the horizontal axis shows the radial direction r of the refraction index distributor 2, and the vertical axis shows the refraction index n, and the characteristic curve shows the refraction index distribution in the refraction index distributor 2. In this example, the refraction index is highest at the center of the refraction index distributor 2, and the refraction index gradually decreases along the radial direction toward the peripheral portion 2b, in a so-called bell-shaped characteristic curve.

In the inclined refraction index distributor 2, the signal light is kept in the central portion while being transmitted in a snaking manner. Accordingly, it is possible to prevent a phase displacement from occurring when the signal light is reflected at the boundary surface of the refraction index, in comparison with the stepwise refraction index distributor. Further, it is possible to narrow the difference in group speed caused by the difference in transmission route of signal light. Therefore, it is possible to perform a wider band signal light transmission.

Furthermore, as described above, in the case when the low refraction index area is formed in the peripheral portion 2b of the refraction index distributor 2, it is possible to increase the signal light trapping effect. Accordingly, it is possible to reduce light leaking out of the refraction index distributor 2. Moreover, it is possible to easily and precisely form the low refraction index area in the peripheral portion 2b by ultraviolet radiation.

In the above description, the case where only one refraction index distributor 2 is formed on the substrate is described as an example. Additionally, in the case where there are two or more refraction index distributors 2, the embodiment can be done in the same manner only by making a mask pattern corresponding to the number of refraction index distributors. Further, besides the case when plural refraction index distributors are arranged in one column as shown in FIG. 1A, it is also possible to arrange them in rows and columns (in a matrix) by making a mask pattern corresponding to the number of refraction index distributors.

Next, on the lower substrate 7, the optical path changing portion 3 having the optical path changing surface 3a optically coupled with the refraction index distributor 2, and the optical waveguides 4 optically coupled with the optical path changing surface 3a are formed, so as to be positioned between the upper substrate 5 and the lower substrate 7, that is, in the substrate with a built-in optical transmission function. Thereby, the optical semiconductor device 1 mounted on the upper substrate 5 and the optical waveguides 4 in the substrate with a built-in optical transmission function are optically coupled via the refraction index distributor 2 and the optical path changing surface 3a. Additionally, in FIG. 1B, the optical waveguides 4 arranged in the substrate are arranged in parallel with the surface of the substrate, but they are not necessarily in parallel with the surface of the substrate, so long as they can be optically coupled with the refraction index distributor 2.

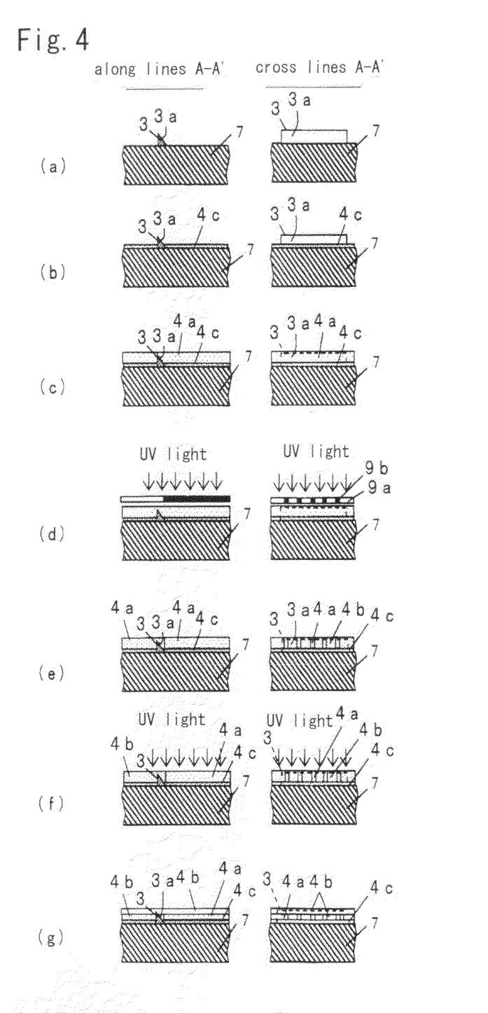

FIGS. 4A to 4G are pairs of cross sectional views of a substantial part of the lower substrate 7 at each step of a process showing an example of a preferred embodiment of the method of forming the optical path changing surface 3a and the optical waveguide 4. In each pair of cross sectional views, a cross sectional view of the substantial part corresponding to the cross sectional view taken along lines A-A′ shown in FIG. 1A is shown on the left side, and a cross sectional view of the substantial part in the orthogonal direction is shown on the right side. Additionally, in this example, in the same manner as in the forming method of the refraction index distributor 2, the case where a photosensitive polymer material that is photobleached is used is described as an example.

As shown in FIG. 4A, the cross section of the optical path changing portion 3 is a triangular prism of a right isosceles triangular shape with the optical path changing surface 3a as its hypotenuse, and is formed of glass, metal, resin and the like. Additionally, one surface forming the right angle in the cross section is mounted on the lower substrate 7, and the surface forming the hypotenuse in the cross section is arranged to face the optical waveguide 4 side. In order to fix the optical path changing portion 3 onto the lower substrate 7, adhesive may be used. A metal joint method such as soldering or the like may also be used.

On the hypotenuse of the optical path changing portion 3, which is at an angle of approximately 45 degrees to the upper surface of the lower substrate 7, metal coating (not shown) is applied as an light reflection film to increase the refraction ratio of the light emitted from the optical semiconductor device 1 to the optical waveguide 4 or the refraction ratio of the incoming light from the optical waveguide 4 to the optical semiconductor device 1, and thereby the hypotenuse of the optical path changing portion 3 functions as the optical path changing surface 3a that performs preferable optical reflection. Thereby, the optical path changing portion 3 has a function to perform the optical path conversion of signal light. That is, the optical path changing portion 3 changes the direction of the signal light entering vertically the lower substrate 7 via the refraction index distributor 2 from the optical semiconductor device 1, 90 degrees into the direction parallel to the upper surface of the lower substrate 7. Consequently, the optical path changing portion 3 makes the signal light travel through the optical waveguide 4 in parallel with the upper surface of the lower substrate 7. Alternatively, the optical path changing portion 3 changes the direction of the signal light coming from the optical waveguide 4 in parallel with the upper surface of the lower substrate 7, 90 degrees into the direction vertical to the lower substrate 7 and makes the signal light travel through the refraction index distributor 2 toward the optical semiconductor device 1.

Additionally, when the optical path changing surface 3a is a hypotenuse inclined at an angle of 45 degrees to the upper surface of the lower substrate 7, it also becomes an optical reflection surface that is inclined at an angle of 45 degrees to the axis of the refraction index distributor 2 arranged vertically to the upper surface of the lower substrate 7. Thus, in the case when the optical path changing surface 3a has a light reflection surface inclined at an angle of 45 degrees to the axis of the refraction index distributor 2, the signal light transmitted along the optical axis of the refraction index distributor 2 is reflected to the direction orthogonal to the axis of the refraction index distributor 2. Thereby, the optical path changing surface 3a can change the transmission direction of the signal light so as the signal light becomes in parallel with the axis of the optical waveguides 4 whose axis is arranged so as to become orthogonal to the axis of the refraction index distributor 2.

Next, as shown in FIG. 4B, on the upper surface of the lower substrate 7 on which the optical path changing portion 3 is arranged, the same photosensitive polymer material as the material forming the refraction index distributor 2 is applied in an even thickness and subjected to the pre-baking process. By using the same material as that of the refraction index distributor, it is possible to reduce the reflection of the signal light. Thereby, the lower clad portion 4c of the optical waveguide 4 is formed.

Next, as shown in FIG. 4C, again on the lower clad portion 4c, photosensitive polymer material is applied to form the core portion 4a of the optical waveguide 4, and the pre-baking process is carried out to solidify the material. This pre-baking process is performed at approximately 100° C. for several minutes.

Next, as shown in FIG. 4D, through the photo mask 9 where the light blocking portion 9b corresponds to a desired pattern of the core portion 4a of the optical waveguide 4, ultraviolet light is radiated from above. Thereby, the refraction index of the portion radiated by ultraviolet light declines according to the exposure time and the light amount.

Then, as shown in FIG. 4E, the core portion 4a is formed. At this moment, the pattern of the light blocking portion 9b is formed so that the end of the core portion 4a of the optical waveguide 4 should be positioned at a specified distance from the optical path changing surface 3a. By making the optical path changing surface 3a and the optical waveguide 4 face each other at a distance, the transmitted light from the optical path changing surface 3a enters the end of the optical waveguide 4 precisely at right angles. As a result, it is possible to realize highly efficient optical coupling between the refraction index distributor 2 and the optical waveguide 4 via the optical path changing surface 3a.

Next, as shown in FIG. 4F, without a photo mask, the entire surface of the photosensitive polymer material is radiated by ultraviolet light for a specified time. Thereby, to a certain depth from the upper surface, the photo bleaching phenomenon is caused.

Then, as shown in FIG. 4G, the upper clad portion 4b is formed. Thereby, an optical waveguide layer 4 having the core portion 4a surrounded by the upper clad portion 4b and the lower clad portion 4c having a low refraction index is formed.

Thereafter, the upper substrate 5 on which the refraction index distributor 2 is formed by the methods shown in FIG. 2 and FIG. 3, and the lower substrate 7 on which the optical path changing portion 3 having the optical path changing surface 3a and the optical waveguide 4 are formed by the method shown in FIG. 4 are mutually positioned and jointed by adhesive and the like to be made into one body. Thereby, the substrate with a built-in optical transmission function according to the present invention having the optical coupling structure of the present invention can be obtained.

Again, with reference to FIG. 1B, description will be made. In the substrate with a built-in optical transmission function according to the present invention mentioned above, when the optical semiconductor device 1 is a surface emitting type laser diode, the signal light emitted from the device, in general, spreads radially in the range of full width at half maximum (or divergence angle) from 20 degrees to 30 degrees. On the other hand, since the thickness of the general electrodes 6a and 6b is several μm, the signal light enters the refraction index distributor 2 at roughly the same size as the size of the beam spot of the emitted light, and the reflection of the signal light is kept in the inside of the refraction index distributor 2 (in the case of the stepwise refraction index distributor). Also, the signal light goes snaking through the refraction index distributor 2 (in the case of inclined refraction index distributor). Thereby, it is possible to reduce the attenuation amount of the signal light due to loss of the signal light that occurs when the signal light scatters around from the refraction index distributor 2. That is, in the case when the optical semiconductor device 1 is a surface emitting type laser diode, by mounting the optical semiconductor device 1 onto the upper substrate 5 with its active region facing the upper substrate 5 side, optical coupling can be easily structured. Accordingly, it is possible to realize a highly efficient optical coupling structure easily without using any special parts.

Further, the optical waveguide 4 is made of a photosensitive polymer material, and thereby the optical waveguide 4 can be formed only by an exposure process by ultraviolet radiation. Accordingly, it is possible to simplify the manufacturing process and reduce the manufacturing cost.

Furthermore, the optical waveguide 4, in the case where the clad portion 4b as a low refraction index area is formed around the core portion 4a by ultraviolet radiation, can be formed only by the exposure process using a photo mask with the portion corresponding to the core pattern of the optical waveguide 4 made as a dark portion to block off light. Accordingly, it is possible to complete the manufacturing process of the optical waveguide 4 in a short time and to reduce the manufacturing cost thereof.

The signal light from the refraction index distributor 2, in the case where the refraction index distributor 2 is a stepwise refraction index distributor, spreads at the angle corresponding to the refraction index difference between the central portion 2a and the peripheral portion 2b. In this case, by adjusting the refraction index difference, it is possible to control the divergence angle to a desired value. Further, in the case when the refraction index distributor 2 is an inclined refraction index distributor, the signal light snakes in the refraction index distributor 2 in a specified cycle. In this case, the signal light is kept in the central portion 2a while being transmitted through the same in a snaking manner. Accordingly, it is possible to prevent the phase displacement, which occurs when the signal light is reflected at the boundary surface of the refraction index, from occurring. In addition, it is possible to narrow the difference in group speed caused by the difference in transmission route of signal light and, therefore, it is possible to perform a wider band signal light transmission.

Then, the signal light emitted through the refraction index distributor 2 goes through the upper clad portion 4b of the optical waveguide 4, and the traveling direction thereof is changed 90 degrees by the optical path changing surface 3a of the optical path changing portion 3. Accordingly, the signal light enters the core portion 4a of the optical waveguide 4 and goes through the inside thereof. The end surface of the core portion 4a of the optical waveguide 4 is vertical to the traveling direction of the signal light, and faces the optical path changing surface 3a at a distance d at the extreme vicinity of the optical path changing portion 3. Therefore, the light transmitted from the optical path changing surface 3a precisely enters the end of the optical waveguide 4 at right angles. Accordingly, a higher amount of signal light enters the core portion 4a of the optical waveguide 4 by optical coupling via the optical path changing surface 3a than in the case by the prior art optical coupling structure shown in Patent Document 1.

In the above example, description is made on the case where the optical semiconductor device 1 is a surface emitting type device. In the case where the optical semiconductor device 1 is a surface light receiving type device, the signal light is emitted, transmitted, reflected at the optical path changing surface 3a so as to change its optical path, and enters the optical waveguide 4. However, in this case, these steps take place in the reverse sequence. That is, the signal light is transmitted through the optical waveguide 4, emitted from the core portion 4a, and reflected by the optical path changing surface 3a of the optical path changing portion 3, and its light path is changed 90 degrees and the light enters the refraction index distributor 2. Lastly, the signal light reaches the active region of the surface light receiving type optical semiconductor device 1, which is a surface light receiving type photo diode or the like and is received thereby.

In the substrate with a built-in optical transmission function according to the present invention, when the optical semiconductor 1 is a surface emitting type laser diode or a surface light receiving type photo diode, by only mounting one of these optical semiconductor devices 1 on the upper substrate 5 with its active region facing the upper substrate 5 side, optical coupling can be easily structured. Accordingly, it is possible to easily realize a highly efficient optical coupling structure without using any special parts.

According to the substrate with a built-in optical transmission function of the present invention, by the structure mentioned above, these optical semiconductor device 1 of the surface emitting type device and optical semiconductor device 1 of the surface light receiving type device are mounted and fixed onto a single substrate (for example, a single upper substrate 5). Furthermore, the optical coupling structure according to the present invention is arranged in the substrate (substrate structured by the upper substrate 5 and the lower substrate 7) to correspond to the respective devices. Accordingly, it is possible to transmit the signal light in the substrate in a preferable manner.

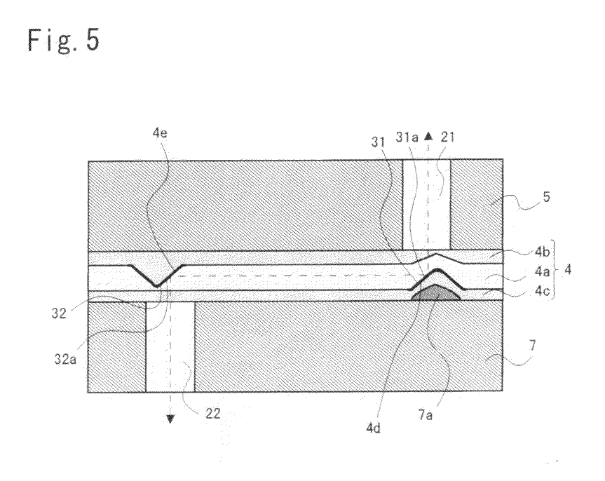

FIG. 5 is a cross sectional view schematically showing another preferred embodiment of the optical coupling structure and the substrate with a built-in optical transmission function using the same according to the present invention.

The substrate with a built-in optical transmission function shown in FIG. 5 includes an upper substrate 5, a lower substrate 7 arranged in parallel with the upper substrate 5, an optical waveguide 4 formed between the upper substrate 5 and the lower substrate 7, a first refraction index distributor 21 formed to go through the upper substrate 5, and a first optical path changing surface 31a that is optically coupled with the optical waveguide 4 and the first refraction index distributor 21, and changes the light path between them. The first refraction index distributor 21 has the same structure as that of the refraction index distributor 2 in any of the preferred embodiments. Accordingly, the optical waveguide 4, the first refraction index distributor 21, and the first optical path changing surface 31a form the optical coupling structure according to the present invention.

Further, in the substrate with a built-in optical transmission function shown in FIG. 5, at a position away from the first optical path changing surface 31a in the optical waveguide 4, a second optical path changing surface 32a is arranged to face the first optical path changing surface 31a. Moreover, through the lower substrate 7, a second refraction index distributor 22 is formed, and the second optical path changing surface 32a is optically coupled with the optical waveguide 4 and the second refraction index distributor 22, and changes the optical path between these. The second refraction index distributor 22 also has the same structure as that of the refraction index distributor 2 in any of the preferred embodiments. Accordingly, the optical waveguide 4, the second refraction index distributor 22, and the second optical path changing surface 32a form the optical coupling structure according to the present invention.

Additionally, in FIG. 5, the optical waveguide 4 arranged in the substrate is arranged in parallel with the surface of the substrate, however, it is not necessarily in parallel with the surface of the substrate, so long as it can be optically coupled with the first and second refraction index distributors 21, 22.

The broken line in FIG. 5 schematically shows the optical paths of the signal light. One of the optical paths of the signal light goes through the first refraction index distributor 21 and its direction is changed to the optical waveguide 4 by the first optical path changing surface 31a. Next, the optical path goes through the optical waveguide 4 and its direction is changed to the second refraction index distributor 22 by the second optical path changing surface 32a. Then, the optical path goes through the second refraction index distributor 22, and exits the substrate. The other optical path travels the route reverse to this.

The optical waveguide 4 includes an upper clad portion 4b, a core portion 4a and a lower clad portion 4c. The optical waveguide 4 is formed of a photosensitive polymer material, for example, polyimide, epoxy, acryl, polysilane and the like. Preferably, such photosensitive polymer material has a high transmittance in the wavelength of the signal light. The refraction index of the core portion 4a is structured to be several % higher than that of the upper clad portion 4b and the lower clad portion 4c, and through the core portion 4a, the optical signals transmit at high efficiency.

The optical path changing surface 31a is formed by the process where a V-shaped or U-shaped bent portion 4d is formed on the boundary surface between the core portion 4a and the lower clad portion 4c. The inclined surface included in the bent portion 4d is covered with a light reflection film 31 made of a metal material. The bent portion 4d is convex that protrudes from the lower clad portion 4c to the core portion 4a. One surface of the light reflection film 31 becomes a light reflection surface, that is, the optical path changing surface 31a. Further, the optical path changing surface 32a is formed by the process where a V-shaped or U-shaped bent portion 4e is formed on the boundary surface between the core portion 4a and the upper clad portion 4b. The inclined surfaces included in the bent portion 4e are covered with a light reflection film 32 made of a metal material. The bent portion 4e is convex that protrudes from the upper clad portion 4b to the core portion 4a. One surface of the light reflection film 32 becomes a light reflection surface, that is, the optical path changing surface 32a. As the metal material of the light reflection films 31, 32, gold or copper or the like which are materials having a high reflectance for the signal light may be employed.

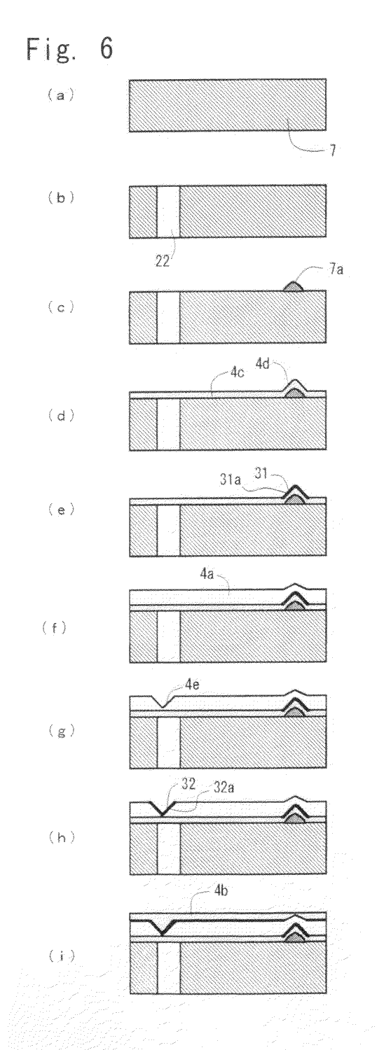

In the embodiment of FIG. 5, as shown in the example mentioned previously, it is not necessary to prepare a separate optical path changing portion. Further, it is possible to form the optical waveguide 4 on the upper surface of the lower substrate 7, and also form the optical path changing surfaces 31a, 32a in the process. Herein, in the processing method using a prior art dicer cutter, it is not possible to form the optical path changing surface 31a on the boundary surface between the optical waveguide 4 and the lower clad portion 4c. As shown in FIG. 5, the bent portion 4d for forming the optical path changing surface 31a, which is on the boundary surface between the core portion 4a and the of the lower clad portion 4c, is formed by arranging a protrusion 7a on the upper surface of the lower substrate 7. This manufacturing method is described in more detail with reference to the next FIG. 6. Thus, in the present invention, on both the upper clad portion 4b and the lower clad portion 4c, it is possible to form the optical path changing surface at an optional position on the boundary surface to the core portion 4a.

Additionally, although not illustrated in the figure, in the substrate with a built-in optical transmission function shown in FIG. 5, an optical semiconductor device may be mounted on the upper substrate 5 or the lower substrate 7, as shown in FIG. 1B. In this case, the active region of the optical semiconductor device faces and is optically coupled with the first refraction index distributor 21 or the second refraction index distributor 22.

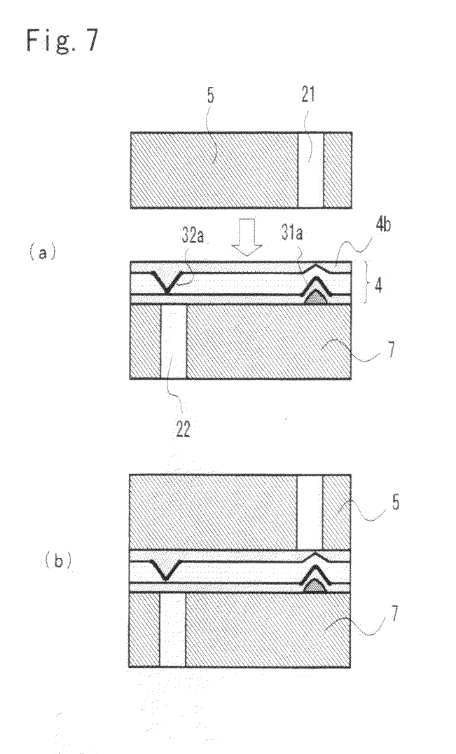

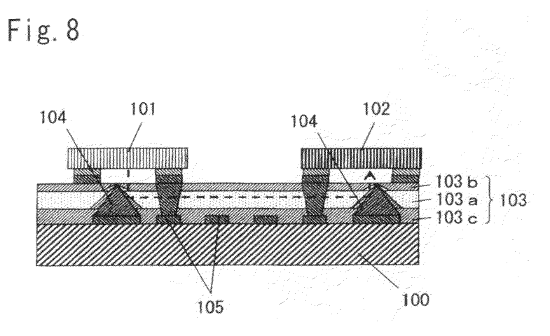

FIGS. 6A to 6H and FIGS. 7A and 7B are cross sectional views of the substantial part of the lower substrate 7 at each step of the process showing an example of the method of manufacturing the substrate with a built-in optical transmission function shown in FIG. 5.

As shown in FIG. 6A, the lower substrate 7 is prepared.

As shown in FIG. 6B, a through hole is made in the lower substrate 7, and the refraction index distributor 22 is formed in the inside thereof. The method of forming the refraction index distributor 22 is as shown in FIG. 2 or FIG. 3.

Next, as shown in FIG. 6C, the protrusion 7a is formed on the upper surface of the lower substrate 7. The cross sectional shape of the protrusion 7a is roughly trapezoidal or semi-elliptic. The position where the protrusion 7a is arranged is the position corresponding to the refraction index distributor 21 in the upper substrate 5 to be jointed in a later process. As the manufacture method, for example, a method where a metal film of copper or gold or the like attached to the lower substrate 7 is raised to form the protrusion 7a may be employed. Alternatively, a method where a protrusion formed beforehand of a metal material or a resin material is adhered to the substrate and the like may be employed.

Next, as shown in FIG. 6D, a transparent polymer material is applied on the upper surface of the lower substrate 7 in a certain film thickness, and subjected to the pre-baking process to be solidified. It is preferable that the transparent polymer material is the same photosensitive polymer material as the material to form the refraction index distributor 22, because it reduces the reflection of the signal light. Thereby, the lower clad portion 4c of the optical waveguide 4 is formed. At this moment, in the portion where the protrusion 7a is arranged, the lower clad portion 4c rises along the outer ward shape of this protrusion 7a, thereby the bent portion 4d rises and consequently, the bent portion 4d is formed.

Next, as shown in FIG. 6E, the surface of the bent portion 4d of the lower clad portion 4c is covered with the light reflection film 31. For example, a metal material such as copper or gold or the like is applied onto the surface of the bent portion 4d by a method such as application, plating or deposition or the like. Further, the surface of the light reflection film 31 is made smooth. Thereby, the optical path changing surface 31a is formed.

Next, as shown in FIG. 6F, onto the surface of the lower clad portion 4c including the light reflection film 31, a transparent polymer material whose refraction index is higher than that of the lower clad portion 4c is applied. Further, this transparent polymer material is subjected to the pre-baking process to be solidified, and cut appropriately so as to obtain a desired pattern of the core portion 4a and thereby the core portion 4a is formed. Alternatively, the photosensitive polymer material is applied as shown in FIG. 4C. and, as shown in FIGS. 4D and 4E, ultraviolet light is radiated through a photo mask corresponding to the desired pattern of the core portion 4a. and thereby the core portion 4a is formed. As shown in FIG. 6F, the upper surface of the core portion 4a rises at the portion forming the optical path changing surface 31a. This rising portion gives an advantage because light travels in accordance with the degree of the inclination of the rising portion in the case where the optical path is changed from the core portion 4a to the upper direction.

Next, as shown in FIG. 6G, by use of a method such as cutting by a dicer cutter or the like, or molding by heating or the like, the surface of the core portion 4c is partially removed, and thereby the bent portion 4e is formed. The position where the bent portion 4e is arranged is the position corresponding to the refraction index distributor 22.

Next, as shown in FIG. 6H, the surface of the bent portion 4e is covered with the light reflection film 32. This method is the same as that for the light reflection film 31 in FIG. 6E. Thereby, the optical path changing surface 32a is formed.

Next, as shown in FIG. 6I, onto the surface of the core portion 4a including the light reflection film 32, the transparent polymer material is applied and solidified and thereby the upper clad portion 4b is formed. When the upper clad portion 4b is formed by, for example, spin coating, the convex on the upper surface of the core portion 4a created by the protrusion 7a is reduced in height and the upper surface of the upper clad portion 4b becomes almost flat. Finally, the entire surface of the core portion 4a is appropriately subjected to the post-baking process to facilitate curing and thereby the manufacturing of the optical waveguide 4 is completed.

Moreover, as shown in FIG. 7A, to the upper surface of the optical waveguide 4 formed on the lower substrate 7, the upper substrate 5 is affixed and laminated. Although not illustrated in the figure, at this moment, resin is applied to the underside surface of the upper substrate 5 for adhesion. Additionally, to the upper substrate 5, the first refraction index distributor 21 is formed beforehand by the method shown in FIG. 2 or FIG. 3. The position of the first refraction index distributor 21 corresponds to the position of the optical path changing surface 31a formed on the lower substrate 7.

It may be well understood by those skilled in the art that the present invention is not limited to the above preferred embodiments, but the present invention may be embodied by appropriately modifying the structural components thereof without departing from the spirit or essential characteristics thereof. For example, a manufacturing sequence may be employed where, firstly, the refraction index distributor 21 is formed on the upper substrate 5, secondly, the photosensitive resin is applied onto the surface (underside surface) at the side opposite to the mounting surface (upper surface) of the optical semiconductor device and the optical waveguide 4 is formed, then the optical path changing surface is arranged.

What is claimed is:

1. An optical coupling structure comprising optical waveguides, cylindrical first and second refraction index distributors in which a refraction index decreases from a central portion toward a peripheral portion in a radial direction, a first optical path changing surface that is optically coupled with both the optical waveguides and the first refraction index distributors so as to change optical paths between the optical waveguides and the first refraction index distributors, and a second optical path changing surface that is positioned at a distance from the first optical path changing surface and is optically coupled with both the optical waveguides and the second refraction index distributors so as to change optical paths between the optical waveguides and the second refraction index distributors,
wherein respective cylindrical axes of the first and second refraction index distributors are arranged so as to face different directions with respect to the optical waveguides.

2. An optical coupling structure according to claim 1, wherein the first and second refraction index distributors distribute the refraction index in such a manner that the refraction index decreases from the central portion toward the peripheral portion in the radial direction in a stepwise manner.

3. An optical coupling structure according to claim 1, wherein the first and second refraction index distributors distribute the refraction index in such a manner that the refraction index gradually decreases from the central portion toward the peripheral portion in the radial direction in a concentric manner.

4. An optical coupling structure according to claim 1, wherein the first and second refraction index distributors are formed of a photosensitive polymer material, and the refraction index is distributed by radiation of ultraviolet light.

5. An optical coupling structure according to claim 1, wherein the optical waveguides are formed of a photosensitive polymer material, and core portions and clad portions around the core portions are formed by radiation of ultraviolet light.

6. An optical coupling structure according to claim 1, wherein each of the first and second optical path changing surfaces is equipped with a light reflection surface that is inclined to optical axes of each of the first and second refraction index distributors, and the light reflection surfaces are formed on bent portions on boundary surfaces between the core portions and the clad portions of the optical waveguides.

7. An optical coupling structure according to claim 1, wherein each of the first and second optical path changing surfaces is equipped with a light reflection surface that is inclined at an angle of 45 degrees to each of the optical axes of the first and second refraction index distributors.

8. An optical coupling structure according to claim 1, wherein each of the optical path changing surfaces and ends of the optical waveguides face each other at a distance.

9. An optical coupling structure according to claim 1, further comprising first and second optical semiconductor devices that optically couple with the optical waveguides via the first and second refraction index distributors and the first and second optical path changing surfaces and have active regions respectively facing each of the first refraction index distributors and the second refraction index distributors.

10. An optical coupling structure according to claim 9, wherein the optical semiconductor devices are a surface emitting type laser diode or a surface light receiving type photo diode.

11. A substrate with a built-in optical transmission function comprising an optical coupling structure according to claim 1, and a substrate, wherein the optical waveguides and the first and second optical path changing surfaces are formed in the substrate, and each of the first and second refraction index distributors is formed through the substrate.

12. A substrate with a built-in optical transmission function comprising an optical coupling structure according to claim 1, a first substrate, and a second substrate that is arranged in parallel with the first substrate, wherein the optical waveguides and the first and second optical path changing surfaces are formed between the first and second substrates, and each of the first refraction index distributors and each of the second refraction index distributors are formed through the first and second substrates respectively.

13. A substrate with a built-in optical transmission function comprising an optical coupling structure according to claim 9 and a substrate, wherein the optical waveguides and the first and second optical path changing surfaces are formed on one surface of the substrate, and the optical semiconductor devices are arranged on the other surface of the substrate, and each of the first and second refraction index distributors is formed through the substrate.

14. A substrate with a built-in optical transmission function comprising an optical coupling structure according to claim 9, a first substrate, and a second substrate that is arranged in parallel with the first substrate, wherein the optical waveguides and the first and second optical path changing surfaces are formed between the first and second substrates, and the optical semiconductor devices are each arranged on the surfaces opposite to the surfaces on which the optical waveguides and the first and second optical path changing surfaces are formed in the first and second substrates, and each of the first refraction index distributors and each of the second refraction index distributors are formed through the first and second substrates respectively.

15. A method of manufacturing a substrate with a built-in optical transmission function that comprises optical waveguides formed in a substrate, cylindrical refraction index distributors, and an optical path changing surface optically coupled with both the optical waveguides and the refraction index distributors so as to change optical paths direction between the optical waveguides and the refraction index distributors, and the optical path changing surface is equipped with a light reflection surface that is inclined to the optical axes of the refraction index distributors, and the light reflection surface is formed by bending the boundary surfaces between core portions and clad portions of the optical waveguides, wherein
steps of forming the optical path converting surface includes the steps of:
after forming the core portions, removing the core portions at the positions intersecting with the optical axes of the refraction index distributors and thereby forming inclined surfaces on the surfaces of the core portions; and
covering the inclined surfaces with a light reflection film and thereby forming the light reflection surfaces, and
forming the clad portions on the core portions including portions on the light reflection film.

16. A method of manufacturing a substrate with a built-in optical transmission function that comprises optical waveguides formed in a substrate, cylindrical refraction index distributors, and an optical path changing surface optically coupled with both the optical waveguides and the refraction index distributors so as to change optical paths direction between the optical waveguides and the refraction index distributors, and the optical path changing surface is equipped with a light reflection surface that is inclined to the optical axes of the refraction index distributors, and the light reflection surface is formed by bending the boundary surfaces between core portions and clad portions of the optical waveguides, wherein
steps of forming the optical path changing surface comprises the steps of:
before forming the clad portions, forming protrusions at the positions intersecting with the optical axes of the refraction index distributors;
forming the clad portions on the protrusions along the outer ward shape of the protrusions and thereby forming inclined surfaces on the surfaces of the clad portions,
covering the inclined surfaces with a light reflection film and thereby forming the light reflection surfaces; and
forming the core portions on the clad portions including portions on the light reflection film.
